(19) United States
(12) Patent Application Publication
(10) Pub. No.: US 2008/0075553 A1
(43) Pub. Date: Mar. 27, 2008

(54) Expansion anchor

(75) Inventors: Rosa Maria Gonzalez Carquijero, Feldkirch (AT); Nikolaus Hannoschoeck, Grabs (CH); Otto Noser, Schaan (LI); Bernhard Sander, Munich (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/900,294

(22) Filed: Sep. 10, 2007

(30) Foreign Application Priority Data
Sep. 21, 2006 (DE) 10 2006 000 475.2

(51) Int. Cl. F16B 13/14

(52) U.S. Cl. 411/82.1

(57) ABSTRACT

An expansion anchor has an anchor member (21; 51) that has a longitudinal bore (24), a load application element (25, 55) and an expansion section (22; 52) located between first and second sections (26, 27; 56, 57) of the anchor member (21) and a cross-section of which widens from the first section (26; 56) toward the second section (27; 57; and an expansion sleeve (13; 43) having an axial longitudinal bore (14) with which it is guided over the first section (26; 56) of the anchor member (21; 41) and an expansion region (15) located adjacent to the expansion section (22; 52) of the anchor member (21; 41), with at least one of the anchor member (21; 41) and the expansion sleeve (13; 43) having at least one through-opening (18; 58) for a hardenable mass (31) and which opens into one of the axial bore (54) of the anchor member or the axial bore (14) of the expansion sleeve.

### BACKGROUND OF THE INVENTION

1. Field of the Invention

The present invention relates to an expansion anchor for being anchored in a borehole and having an anchor member. The anchor member has a first axial longitudinal bore, load application means, a first section, a second section, and an expansion section located between the first and second sections and a cross-section of which widens from the first section toward the second section. Another anchor member is formed as an expansion sleeve which has a second axial longitudinal bore with which it is guided over the first section of the anchor member, and an expansion region located adjacent to the expansion section of the anchor member.

2. Description of the Prior Art

Expansion anchors of the type discussed above are used for an attachment of add-on parts to constructional components, e.g., masonry or a concrete constructional component. To this end, an anchor is inserted in a preliminary formed borehole and is forcelockingly anchored there by expansion of the anchor members. The to-be-attached add-on part is mounted on the section of the expansion anchor projecting from the borehole, so that expansion anchor becomes loaded after being set. An expansion anchor of the type discussed above is disclosed, e.g., in PCT publication WO 2005/031176 A1.

The drawback of the known solution consists in that for transmission of big loads, large expansion forces must be applied to the constructional component. Correspondingly, edge and axis distances should be selected so that they are sufficiently large so that the acting forces do not overlap and cannot lead to a failure of the formed attachments. In addition, media, which are harmful to the expansion anchor, can penetrate into the gap between the expansion anchor and the borehole wall.

German Publication DE 103 60 156 A1 discloses an expansion anchor that is forcelockingly anchored and in material-locking manner and that has an anchor rod with an anchor member and an anchoring region, which is provided with a plurality of depressions, and an expansion sleeve. The anchor member has an expansion section that has a cross-section widening from a first section toward the second section or in the direction of a free end of the anchor rod for expanding the expansion sleeve. The expansion anchor is driven in a borehole filled with mortar used as hardenable mass. With an axial displacement of the anchor member in a direction opposite the setting direction, the anchor member is pulled into the expansion sleeve, whereby the expansion region of the expansion sleeve expands and a forcelocking anchoring of the expansion anchor is achieved. The set expansion anchor then can be immediately loaded to a load level determined by the mechanical anchoring. With this expansion anchor, in addition to a direct, at least partial load bearing capacity, the borehole is sealed with the mortar and, upon complete hardening of the mortar, the anchoring values of the expansion anchor are increased. Therefore, smaller expansion forces, which are produced by the forcelocking anchoring, suffice to achieve a desired load value in an end position of the expansion anchor.

The drawback of the expansion anchor of the above-described German publication consists in that the setting process of the expansion anchor often is carried out by the point in time at which the mortar has already began to harden. The setting process of the expansion anchor interferes with bonding of the mortar, which leads to reduction of the anchoring value.

Accordingly, an object of the invention is to provide an expansion anchor in which the foregoing drawback is eliminated, and the expansion anchor can be at least partially loaded immediately after having been set.

Another object of the present invention is to provide an expansion anchor having a large load value.

### SUMMARY OF THE INVENTION

This and other objects of the present invention, which will become apparent hereinafter, are achieved by providing, in at least one of the anchor member and the expansion sleeve, at least one through-opening for the hardenable mass that opens toward the longitudinal bore formed in the anchor member.

The hardenable mass, e.g., one- or multi-component mortar or glue is liquid or semi-liquid in the non-reacted condition. Upon filling of the borehole with the hardenable mass after the forcelocking anchoring of the expansion anchor, the hardenable mass flows through the at least one through-opening into the remaining space between the expansion anchor and the borehole wall and/or borehole bottom. Upon setting of the anchor into a borehole that was filled with the hardenable mass before the displaceable portion of the hardenable mass enters the space, which is enclosed by the expansion anchor, through the at least one through-bore. After hardening of the hardenable mass, the expansion anchor becomes, to a large extent, anchored in the constructional component in a material-locking manner. The inventive expansion anchor has advantages of a connection anchor, with the expansion anchor being capable of withstanding a load directly after being anchored, and having high anchoring values in the hardened condition of the hardenable mass.

If in order to obtain a forcelocking anchoring of the expansion anchor, the expansion sleeve is pushed over the anchor member, the anchor member is not displaced any more in the axial direction upon widening of the expansion region of the expansion sleeve and the bonding of the hardenable mass is not interfered with even when the borehole was filled with the hardenable mass in advance. This permits to achieve maximal anchoring values. At the same time, the expansion anchor can be loaded to a load level, which is defined by the mechanical anchoring, directly after setting process. The expansion forces that act on the expansion anchor in the mounting condition of the secured add-on part, are usually smaller than the forces in the subsequent operational condition. After hardening of the hardenable mass, the attachment can be loaded to a necessary high load level. Because the acting expansion forces of the expansion anchor act at a lower lever, smaller edge and axis differences can be realized at the same load with an expansion anchor that is only formlockingly anchored.

The first axial bore in the anchor member extends in the direction of the longitudinal axis of the expansion anchor and is formed, e.g., as a through-bore. Advantageously, the load application means is formed as a threaded section, e.g., as an inner thread that is formed, at least sectionwise, in the first axial longitudinal bore. Alternatively, the first axial longitudinal bore is formed as a blind bore that is provided, at least sectionwise, with load application means. The load application means provides for connection of attachment means, which has connection means adapted to the load application means of the anchor member, with the anchor member.

An expansion section of the anchor member, which cooperates with the expansion sleeve during the setting process, widens in the setting direction, e.g., in the direction of the second section of the anchor member and is formed, e.g., as a conical section. Thereby, a simple expansion of the expansion region of the expansion sleeve during setting of the expansion anchor is insured. Alternatively, the expansion section of the anchor member can have a concave, convex, and discontinuous profile. Advantageously, the attachment means is formed as an anchor or treaded rod having an outer thread complementary to the inner thread that forms the load application means of the anchor member.

The attachment means can be provided with a longitudinal bore through which filling of the borehole with a hardenable mass can take place even with the attachment means already connected with the anchor. Such attachment means can have, in addition to the longitudinal bore, along its longitudinal extent, a transverse hole connected with the longitudinal bore and through which the hardenable mass, which is fed into the longitudinal bore, can exit in different regions of the borehole.

For setting the inventive expansion anchor, the anchor member is driven in a preliminary formed and, advantageously, cleaned borehole until the anchor member reaches the bottom of the borehole. Then, the expansion sleeve is driven into the borehole with its expansion region facing in the drive-in direction, and is pushed with a setting tool such as, e.g., a hammer in the direction of the borehole bottom, whereby the expansion region of the expansion sleeve is expanded by the expansion section of the anchor member. During the setting process, no axial displacement of the anchor member in the direction of the longitudinal axis of the expansion anchor takes place. Advantageously, the expansion region of the expansion sleeve has a longitudinal slots so that upon expansion of the expansion region, a plurality of expansion strips is formed which contact the wall of the borehole, producing a forcelocking connection between the borehole wall and the expansion anchor. Thereafter, a hardenable mass is fed into the borehole and which penetrates into the remaining space in the borehole through the at least one through-opening in the anchor member or the expansion sleeve. After the hardening of the hardenable mass, a material-locking anchoring of the expansion anchor is insured. Finally, an attachment element with a connection section, which is formed complementary to the load application means of the anchor member, is connected with the anchor member after the borehole has been filled with the hardenable mass.

According to an alternative embodiment, the attachment means is connected with the anchor member before driving of the anchor member in the borehole, and is driven into the borehole, together with the anchor member, until the anchor member reaches the bottom of the borehole. If the receiving bore of the anchor member is formed as a through-bore and an end of the attachment means projects, in the setting direction, beyond the end, e.g., of the second section of the anchor member, the anchor member is driven, together with the attachment means, until the projecting end of the attachment means reaches the borehole bottom. Finally, the expansion sleeve is driven into the borehole with its expansion region facing in the drive-in direction and is locked, and the hardenable mass is brought into the borehole. The hardenable mass can penetrate into the remaining space through the at least one through-bore, and a material-locking anchoring of the produced attachment is insured also with this alternative embodiment.

Outer sides of the two anchor elements of the inventive expansion anchor, the anchor member and the expansion sleeve, are, e.g., formed smooth or they can have, at least regionwise, a profiled structure in order to improve connection between the anchor elements and the hardenable mass or the constructional component. E.g., in order to provide a profiled structure, the corresponding surfaces can be roughened or be provided with rips. The surfaces of the anchor elements, which contact each other during the expansion process, are formed, e.g., as smooth surfaces.

Preferably, the at least one through-opening is formed in the expansion sleeve and connects the second axial bore with the outer profile of the expansion anchor. The at least one through-opening is formed in the wall of the expansion sleeve extending between the outer profile of the sleeve and the second axial bore. The at least one through-opening has, e.g. a round of polygonal profile. Advantageously, there are provided, in the expansion sleeve, a plurality of through-openings spaced from each other. All of the through-openings have, advantageously, the same profile. Alternatively, the through-openings of the expansion sleeve can have different profiles.

Advantageously, the at least one through-opening is located outside of the expansion region so that in an expanded condition of the anchor elements, the at least one through-opening of the expansion sleeve is not completely covered by the anchor member.

The at least one through-opening can also be provided in the anchor member, connecting the first axial longitudinal bore, which is formed in the anchor member, with the outer profile of the expansion anchor. The at least one through-opening is formed in the wall of the anchor member which extends between the outer profile of the anchor member and the first axial bore. The at least one through-opening has, e.g., a round or polygonal profile. Advantageously, there are provided, in the anchor member, a plurality of through-openings spaced from each other. All of the through-openings have, advantageously, the same profile. Alternatively, the through-openings of the expansion sleeve can have different profiles.

Advantageously, the at least one through-opening is located in the second section of the anchor member so that in an expanded condition of the anchor elements, the at least one through-opening of the anchor member is not completely covered by the expansion region of the expansion sleeve.

According to a further advantageous embodiment of the present invention, at least one through-opening and, preferably, more through-openings are provided in each of the anchor member and the expansion sleeve, which insures an advantageous material-locking anchoring of the expansion anchor in a constructional component.

Advantageously, the through-openings are so arranged in the anchor member and the expansion sleeve that in the expanded condition of the expansion anchor, the respective through-openings are not completely closed by the anchor member and/or the expansion sleeve. Alternatively, the through-openings can be so arranged in the anchor member and the expansion sleeve that they at least partially overlap each other in the forcelockingly anchored condition of the expansion anchor, so that the hardenable mass can flow the overlapping through-openings into the remaining space in the borehole.

Advantageously, the at least one through-opening is formed as a bore that can easily be formed in the expansion sleeve and/or the anchor member of the expansion anchor.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiments, when read with reference to the accompanying drawings.

### BRIEF DESCRIPTION OF THE DRAWINGS

The drawings show:

FIG. 1 a cross-sectional view of a first embodiment of an expansion anchor according to the present invention in an anchored-in-a constructional component condition; and;

FIG. 2 a cross-sectional view of second embodiment of an expansion anchor according to the present invention.

Basically, in both figures, the same elements are designated with the same reference numerals.

### DETAILED DESCRIPTION OF THE PREFERRED EMBODIMENTS

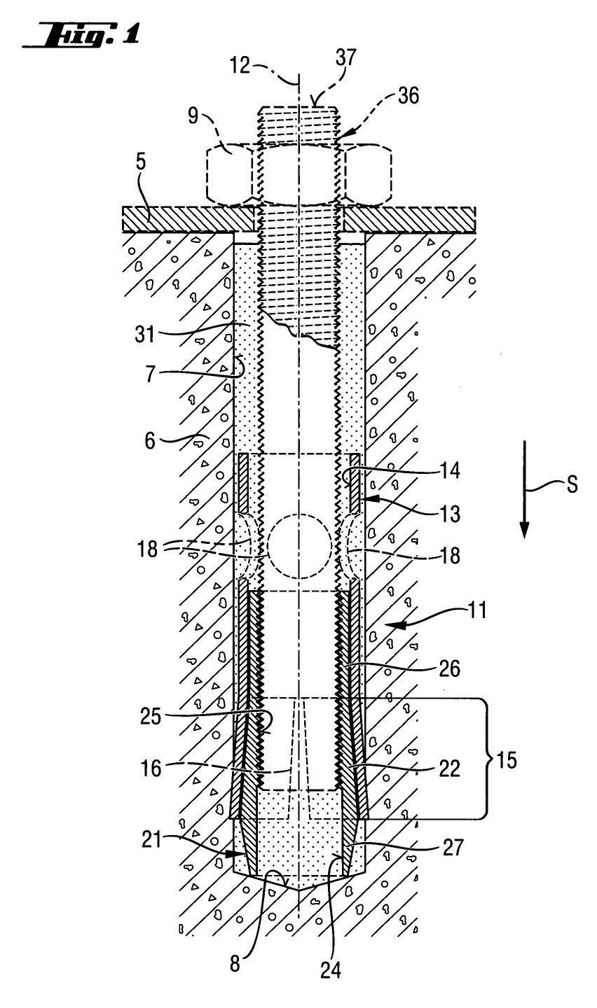

An expansion anchor 11 according to the present invention, which is designed for being anchored in a borehole 7 and which is shown in FIG. 1, extends along a longitudinal axis 12 and includes two anchor elements, namely, an anchor member 21 and an expansion sleeve 13. The anchor member 21 has a first axial longitudinal bore 24, a section with an inner thread that forms load application means 25, a first section 26 and a second section 27, and an expansion section 22 located between the first and second sections 26, 27 and a cross-section of which widens from the first section 26 toward the second section 27.

The expansion sleeve 13 has a second axial longitudinal bore 14 with which it is guided over the first section 26 of the anchor member 21. The expansion sleeve 13 has an expansion region 15 which is formed by a slot 16 and is located adjacent to the expansion section 22 of the anchor member 21. In the expansion sleeve 13, there are provided through-openings 18 for a hardenable mass 31 and which open toward the second axial longitudinal bore 14. Thus, the through-openings 18 connect the second axial longitudinal bore 14 with the outer surface of the expansion sleeve 13 and, thus, with an outer surface of the expansion anchor 11. The through-opening 18 are located outside of the expansion region 15 of the expansion sleeve 13 and are formed in the wall of the expansion sleeve 13.

For a forcelocking anchoring the expansion anchor 11 and for anchoring it in a material-locking manner, a borehole 7 is formed in a constructional component 6, and the anchor member 21 is pushed into the borehole 7 until it contacts the bottom 8 of the borehole 7. Then, the expansion sleeve 13 is inserted in the borehole 7 with the expansion region 15 facing the bottom 8, and is pushed axially in a setting direction S onto the anchor member 21 with a setting tool, not shown. With the expansion sleeve 13 being pushed onto the anchor member 21, the expansion region 15 of the expansion sleeve 13 expands, and the expansion anchor 11 forcelockingly anchors in the constructional component 6, with controlling the displacement of the expansion sleeve 13. Finally, the borehole 7 is filled with the hardenable mass 31, with the liquid or semi-liquid hardenable mass 31 flowing into the remaining space in the borehole 7 through the through-openings 18. Then, an anchor rod, which forms the attachment member 36 (shown with dash lines) and which has an outer thread complimentary to the inner thread of the anchor member 21, is screwed into the inner thread of the anchor member 21. With a nut 9 (shown with dash lines), which is screwed onto a free end 27 of the attachment member 36, an add-on part 5 is secured to the constructional component 6.

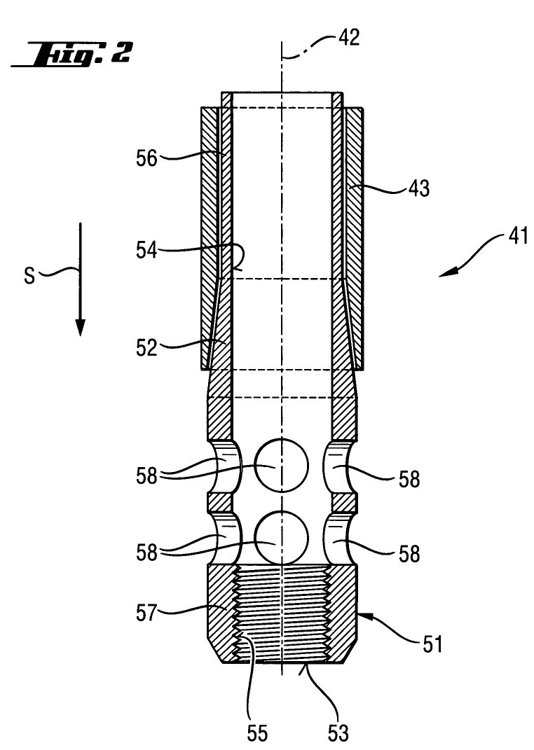

In the expansion anchor 41, which is shown in FIG. 2, a plurality of axially and radially spaced from each other, through-bores 58 for a hardenable mass are formed in an anchor member 51 that has a first section 56, a second section 57, and an expansion section 52 located between the first and second sections 56, 57 and the cross-section of which widens from the first section 56 toward the second section 57. The through-openings 58 are formed in the second section 57 of the anchor member 51 and connect the first axial longitudinal bore 54 of the anchor member 51 with an outer surface of the anchor member 51 and, thus, with an outer surface of the expansion anchor 41. An inner thread that forms load application means 55 for a fastening element (not shown), extends from a free end 53 of the anchor member 57 in a direction opposite the setting direction S over a region of the first axial longitudinal bore 54. An expansion sleeve 43 is guided over the first section 56 that adjoins the expansion region 52. An axial extension of the expansion region 52 and the first section 56 in the direction of the longitudinal axis 42 is greater than a corresponding longitudinal extension of the expansion sleeve 43.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. An expansion anchor for being anchored in a borehole (7), comprising an anchor member (21; 51) having a first axial longitudinal bore (24; 54), load application means (25,55), a first section (26; 56), a second section (27; 57), and an expansion section (22; 52) located between the first and second sections (26, 27; 56, 57) and a cross-section of which widens from the first section (26; 56) toward the second section (27; 57); and an expansion sleeve (13; 43) having a second axial longitudinal bore (14) with which it is guided over the first section (26; 56) of the anchor member (21; 41) and an expansion region (15) located adjacent to the expansion section (22; 52) of the anchor member (21; 41),
wherein at least one of the anchor member (21; 41) and the expansion sleeve (13; 43) has at least one through-opening (18; 58) for a hardenable mass (31) and which opens into one of the first axial bore (54) and the second axial bore (14), respectively.

2. An expansion anchor according to claim 1, wherein the at least one through-opening (18) is formed in the expansion sleeve (13).

3. An expansion anchor according to claim 2, wherein the at least one through-opening (18) is located outside of the expansion region (15) of the expansion sleeve (13).

4. An expansion anchor according to claim 1, wherein the at least one through-opening (58) is formed in the anchor member (51).

5. An expansion anchor according to claim 4, wherein the at least one opening is located in the second section (56) of the anchor member (51).

6. An expansion anchor according to claim 1, wherein the at least one through-opening (18; 58) is a bore.
